(19) United States
(12) Patent Application Publication
(10) Pub. No.: US 2019/0245976 A1
(43) Pub. Date: Aug. 8, 2019

(54) AGENT SELECTION IN A CONTACT CENTER BASED ON LIKELIHOOD OF A COMMUNICATION CHANGING MODES

(71) Applicant: Avaya Inc., Basking Ridge, NJ (US)

(72) Inventors: Jibin George, Pune (IN); Salil Dhawan, Pune (IN); Sandeep Goynar, Pune (IN); Harsimram Jeet Singh, Pune (IN)

(21) Appl. No.: 15/889,981

(22) Filed: Feb. 6, 2018

(51) Int. Cl. H04M 3/523

(52) U.S. Cl. CPC H04M 3/5233; H04M 3/5235

(57) ABSTRACT

The technology disclosed herein enables agent selection based on a likelihood that a received communication will change modes. In a particular embodiment, a method provides receiving a communication in a first mode directed to the contact center from a first user system operated by a first user. The method further provides determining a first likelihood that, at a time after the communication is established with an agent system, the communication will change from the first mode to a second mode. Responsive to the first likelihood satisfying a threshold likelihood, the method provides identifying a first agent of the plurality of agents for handling the communication based on the first mode and the second mode and establishing the communication in the first mode between the first user system and a first agent system operated by the first agent.

### TECHNICAL BACKGROUND

Modern contact centers are capable of exchanging communications with callers using more than one mode of communication. For example, a contact center may allow for voice, video, and text chat communication modes over corresponding voice, video, and text chat communication channels. While some contact centers assign agents to communicate using a single communication mode, many contact centers allow agents to communicate in two or more of the communication modes provided by the communication channels of the contact center. These contact centers are commonly called omni-channel contact centers. Omni-channel contact centers provide more control to agents by consolidating all communication modes/channels with a unified desktop, which allows agents and/or customers to switch modes/channels as appropriate or convenient. As such, an agent handling a communication in a first mode that switches to a second mode, may not be the best fit for handling the communication in the second mode.

### SUMMARY

The technology disclosed herein enables agent selection based on a likelihood that a received communication will change modes. In a particular embodiment, a method provides receiving a communication in a first mode directed to the contact center from a first user system operated by a first user. The method further provides determining a first likelihood that, at a time after the communication is established with an agent system, the communication will change from the first mode to a second mode. Responsive to the first likelihood satisfying a threshold likelihood, the method provides identifying a first agent of the plurality of agents for handling the communication based on the first mode and the second mode and establishing the communication in the first mode between the first user system and a first agent system operated by the first agent.

In some embodiments, determining the likelihood includes determining whether previous communications from the first user have changed from the first mode to the second mode. In some embodiments, determining the likelihood includes determining whether previous communications from one or more other users having similar attributes to the first user have changed from the first mode to the second mode.

In some embodiments, determining the likelihood includes determining the context of the communication and determining whether previous communications having the same context have changed from the first mode to the second mode.

In some embodiments, identifying the first agent includes determining a first skill level in the first mode for each of the plurality of agents, determining a second skill level in the second mode for each of the plurality of agents, and selecting the first agent from the plurality of agents based on the first skill level of the first agent and the second skill level of the first agent satisfying a skill level criteria. In those embodiments, the method may further include determining a topic skill level for each agent of the plurality of agents, wherein selecting the first agent is further based on the topic skill level for the first agent satisfying the skill level criteria.

In some embodiments, identifying the first agent includes determining that the first agent system has communication channel availability for both the first mode and the second mode. In those embodiments, the method may further include reserving a communication channel for the second mode at the first agent system.

In some embodiments, the first mode comprises chat, voice, or video communications and the second mode comprises a different one of the chat, voice, or video communications than the first mode.

In some embodiments, the method includes after establishing the communication, changing the communication from the first mode to the second mode.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to receive a communication in a first mode directed to the contact center from a first user system operated by a first user and determine a first likelihood that, at a time after the communication is established with an agent system, the communication will change from the first mode to a second mode. Responsive to the first likelihood satisfying a threshold likelihood, the program instructions direct the processing system to identify a first agent of the plurality of agents for handling the communication based on the first mode and the second mode and establish the communication in the first mode between the first user system and a first agent system operated by the first agent.

### BRIEF DESCRIPTION OF THE DRAWINGS

FIG. 1 illustrates an implementation for selecting a contact center agent based on the likelihood a communication will change modes.

FIG. 2 illustrates a scenario for the implementation to select a contact center agent based on the likelihood a communication will change modes.

FIG. 3 illustrates another implementation for selecting a contact center agent based on the likelihood a communication will change modes.

FIG. 4 illustrates a scenario for the other implementation to select a contact center agent based on the likelihood a communication will change modes.

FIG. 5 illustrates another scenario for the other implementation to select a contact center agent based on the likelihood a communication will change modes.

FIG. 6 illustrates a computing architecture for selecting a contact center agent based on the likelihood a communication will change modes.

### DETAILED DESCRIPTION

The communication routing described herein considers whether a communication is likely to switch modes when selecting an agent to which the communication is routed. Since a single agent in an omni-channel contact center is able to exchange communications over various communication channels in various modes (e.g., voice, video, text, etc.), the call routing may consider an agent's skill in a particular mode, in addition to the agent's topic related skill, when determining whether to route a communication to that agent. For example, when deciding between two agents having a similar skill level relative to a video communication's topic, the call routing may select one of the two agents that has more skill with video communications. However, the communication routing described herein determines whether the communication, video in the aforementioned example, is likely to switch modes and, specifically, to which mode the communication is likely to switch. The communication routing therefore considers each agent's skill in the original communication mode and their skill in the second mode when the communication is likely to switch to that second mode.

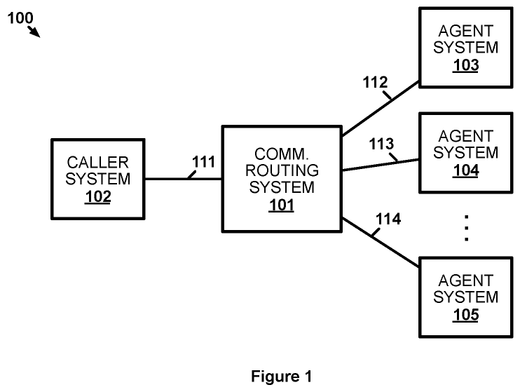

FIG. 1 illustrates implementation 100 for selecting a contact center agent based on the likelihood a communication will change modes. Implementation 100 includes communication routing system 101, caller system 102, agent system 103, agent system 104, and agent system 105. Communication routing system 101 and caller system 102 communicate over communication link 111. Communication routing system 101 and agent system 103 communicate over communication link 112. Communication routing system 101 and agent system 104 communicate over communication link 113. Communication routing system 101 and agent system 105 communicate over communication link 114.

In operation, communication routing system 101 routes communications with a contact center to one of agent system 103, agent system 104, and agent system 105, which are operated by respective agents of the contact center. While only three agent systems are illustrated in implementation 100, it should be understood that the contact center may comprise any number of two or more agent systems (and their operating agents). Caller system 102, agent system 103, agent system 104, and agent system 105 may each comprise a phone, tablet, laptop computer, desktop workstation, or some other type of computing device having processing circuitry and a communication interface circuitry to exchange the communications described below. Agents of the contact center, and their respective agent systems, may be co-located or may be distributed across multiple locations. Each of agent system 103, agent system 104, and agent system 105 is capable of allowing agents to communicate in two or more communication modes and, therefore, includes communication channels for communications in each respective mode. Other agent systems of the contact center may only be capable of one communication mode. Also, while a communication directed to the contact center is the focus of the discussion below, a communication may be instead initiated by the contact center (e.g., communication routing system 101 may select an agent and call out to a caller). Regardless, when determining which agent should handle a communication via an agent system, communication routing system 101 considers whether the communication is likely to switch modes, as described in more detail below.

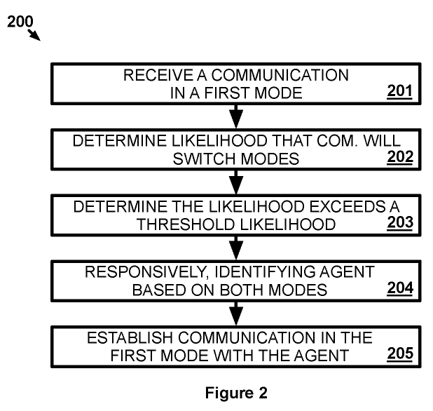

FIG. 2 illustrates scenario 200 for implementation 100 to select a contact center agent based on the likelihood a communication will change modes. In scenario 200, communication routing system 101 receives a communication in a first mode directed to the contact center from caller system 102 operated by a user (201). The first mode may be any communication mode supported by a communication channel of the contact center and communication routing system 101. For example, the communication mode may comprise voice, video, or text chat user communications. Various communication channels may be used to implement the communication modes, including circuit switched voice connection, packet based voice protocol, packet based video protocol, text chat protocol, email messaging, text messaging (e.g., short message service), social networking, or some other type of communication channel.

Upon receiving the communication, communication routing system 101 determines a likelihood that, at a time after the communication is established with one of agent system 103, agent system 104, and agent system 105, the communication will change from the first mode to a second mode (202). The likelihood may be determined by analyzing and factoring in historical data about whether previous communications from the user of caller system 102 have changed from the first mode to the second mode and/or whether previous communications from one or more other users having similar attributes to the user of caller system 102 have changed from the first mode to the second mode. Likewise, communication routing system 101 may factor in context of the communication by determining whether previous communications having the same, or similar, context have changed from the first mode to the second mode. Context for the communication may include a topic of the communication (e.g., sales, tech support, account inquiry, etc.), a time the communication is received, demographics of the caller system 102's user, location of caller system 102, or any other type of information that may be useful in grouping the communication with other similar communications.

Communication routing system 101 further determines whether the likelihood that the communication satisfies a predetermined threshold likelihood (203). For example, a 60% threshold may be used where, if more than 60% of the user's previous communications changed from the current mode to a particular second mode, then communication routing system 101 will determine that the present communication is likely to change to the second mode as well. In some examples, two or more of the likelihood factors will be combined in a metric for indicating likelihood of the communication changing to a second mode and some factors may outweigh other factors when determining that likelihood. For instance, the user's own history of changing modes may outweigh the history of similar user's changing modes. It should be understood that, while the current example only discusses the likelihood that a communication will change from a first mode to a second mode, communication routing system 101 may determine a likelihood that the communication will change from a first mode to any number of other modes. For example, communication routing system 101 may determine a likelihood that a text chat communication will change to a video communication and a likelihood that the text chat communication will change to a voice communication.

Responsive to the likelihood satisfying a threshold likelihood (e.g., 60% from the discussion above), communication routing system 101 identifies an agent of the agents operating agent system 103, agent system 104, and agent system 105 for handling the communication based on the first mode and the second mode (204). Essentially, communication routing system 101 selects an agent that is skilled in handling communications in both modes rather than just one or the other. In some cases, this may involve communication routing system 101 selecting an agent that is less skilled in the first mode than another agent because the agent is more skilled in the second mode than the other agent or the agent. Also, in some cases, if the likelihood that the communication will switch to the second mode is greater than another, higher, threshold likelihood (e.g., 90%), then communication routing system 101 may ignore, or at least factor in very slightly, an agent's skill in the first mode and focus on the agent's skill in the second mode since the likelihood that the communication will switch to the second mode is so great. An agent's skill in a particular mode may be based on supervisor input to communication routing system 101 that indicates the agent's skill in particular modes, may be based on caller surveys about how well an agent performed in particular modes, or based on some other type of information indicative of an agent's skills in various modes. Of course, in addition to considering an agent's skill, communication routing system 101 also considers an agent's expertise with respect to the topic for which the communication was initiated. Thus, the pool of agents from which communication routing system 101 selects an agent may be a pool of agents having skills in the communications topic rather than all agents of the contact center. Also, communication routing system 101 will ensure a particular agent has access to a communication channel for the second mode, as selecting an agent having great skill in the second mode would be useless if the agent cannot communicate in that second mode.

In some examples, communication routing system 101 may further consider an agent's skill with respect to a particular communication channel and not just communication mode. For instance, it may be possible for an agent to be skilled at traditional text chat communication channels but not at text communications over social network channels (e.g., the people that communicate through social networks may respond to the agent's communication style differently than through traditional text chat interfaces). As such, even though the mode of communicating is the same between the two channels, the agent may only be selected for traditional text chat channels. Likewise, if the particular channel is to be considered, communication routing system 101 will further determine a likelihood that the communication will switch to another communication channel and not just another communication mode.

Once the agent has been selected by communication routing system 101, communication routing system 101 establishes the communication in the first mode between caller system 102 and the agent system of agent system 103, agent system 104, and agent system 105 operated by the selected agent (205). The communication is established over a communication channel capable of supporting user communications exchanged in the first mode. Once the communication is established, the user of caller system 102 and the agent of the selected agent system exchange user communications in the first mode over the communication channel. Advantageously, should the communication end up switching to the second mode after being established in the first mode, the selected agent should be sufficiently skilled to communicate with the user of caller system 102 in that mode.

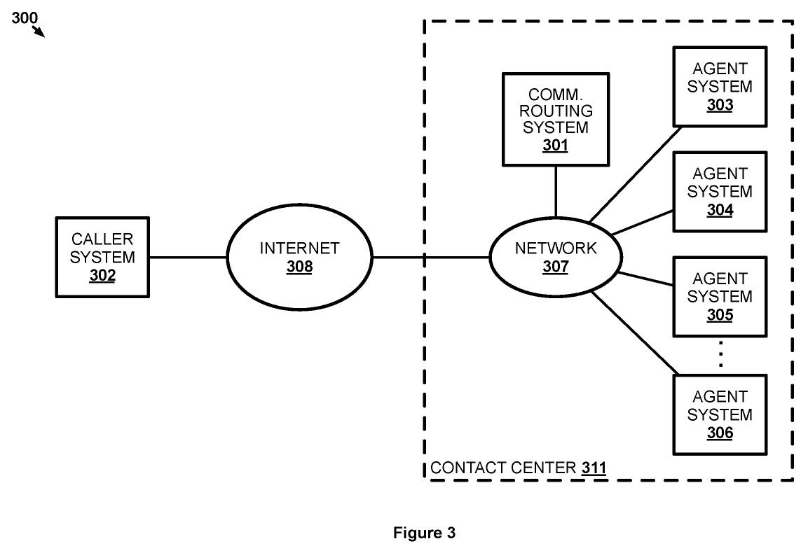

FIG. 3 illustrates implementation 300 for selecting a contact center agent based on the likelihood a communication will change modes. Implementation 300 includes communication routing system 301, caller system 302, agent system 303, agent system 304, agent system 305, agent system 306, contact center network 307, and Internet 308. Although, communication routing system 301, agent system 303, agent system 304, agent system 305, agent system 306, and contact center network 307 are part of contact center 311, no element of contact center 311 need be co-located with another. As such, contact center network 307 may use Internet 308, and possibly other local area networks, to exchange communications with one or more of communication routing system 301, agent system 303, agent system 304, agent system 305, and agent system 306. While only four agent systems are shown in implementation 300, contact center 311 may include any number of agent systems.

In operation, contact center 311 staffs any number of agents to handle communications with users outside of contact center 311 on any number of different topics. Communication routing system 301 is configured to select an agent for a communication and route the communication to the selected agent. Contact center 311 is a omni-channel contact center in this example. In addition to selecting an agent based on the agent's skill level with respect to a topic for the communication, communication routing system 301 further selects an agent based on the agent's skill level with respect to communication modes supported by the communication channels of contact center 311. Moreover, communication routing system 301 selects an agent based on whether the communication is likely to switch modes during the communication to ensure an agent's skill level in both modes is considered when making the selection.

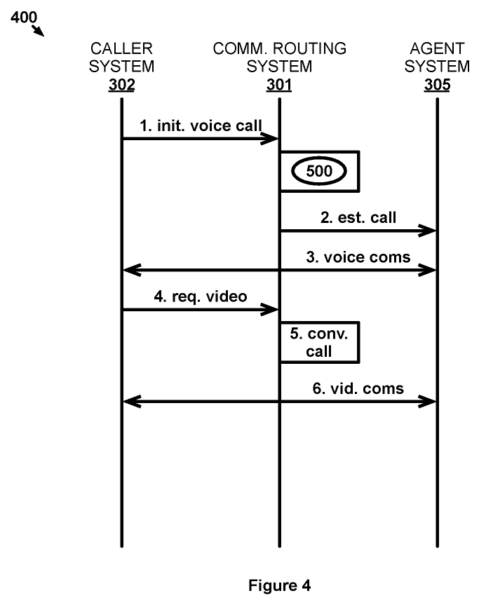

FIG. 4 illustrates scenario 400 for implementation 300 to select a contact center agent based on the likelihood a communication will change modes. In scenario 400, caller system 302 initiates a voice call at step 1 to contact center 311, which is received at communication routing system 301. The voice call may be made over any type of voice channel, including a conventional circuit switched telephone call or a packet based voice communication protocol. The voice call may be initiated at the request of the user of caller system 302, who will be referred to as the caller in this example. Communication routing system 301 performs in accordance with scenario 500 upon receiving the call.

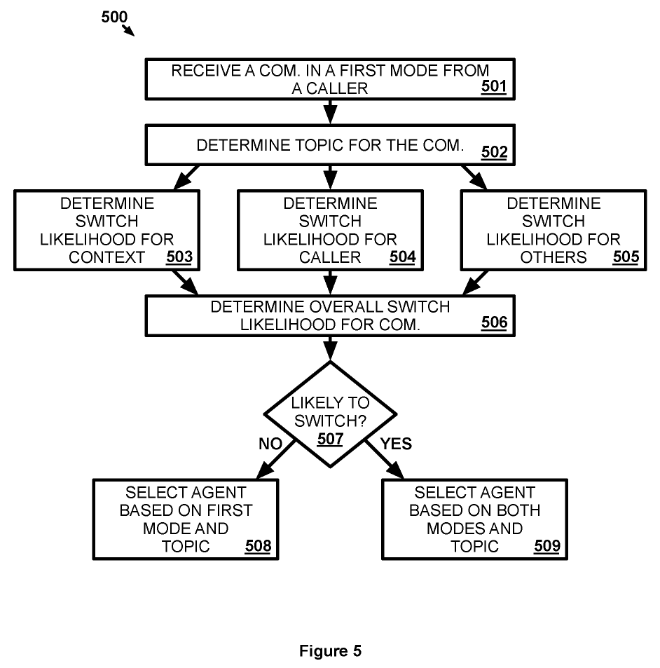

FIG. 5 illustrates scenario 500 for implementation 300 to select a contact center agent based on the likelihood a communication will change modes. In scenario, communication routing system 301 receives the voice call, as already noted above (501). In response to receiving the call, communication routing system 301 determines a topic for the phone call (502). The topic may be anything that the contact center is setup to handle, such as product sales questions, different types of tech support questions, billing issues, general inquiries, or any other type of issue, which may depend on the entity represented by contact center 311 (e.g., business type, educational institution, charity organization, etc.). The topic may be determined via an interactive voice response (IVR) system of contact center 311, via a web interface if the voice call is initiated using a packet protocol from a website (e.g., WebRTC), or any other manner in which a contact center 311 may determine a callers reason for calling. The topic helps communication routing system 301 narrow down the pool of potential agents to which the call may be routed.

Communication routing system 301 further determines a likelihood that the voice call will switch to another mode of communicating. This example focuses on the likelihood that the voice call will switch to video or text but it should be understood that other communication modes may exist to which the voice call could switch and could further be considered by communication routing system 301. Likewise, rather than considering only the mode of communicating, communication routing system 301 may further consider the communication channel over which the mode switch will take place. For example, a text chat may take place over one of many social network channels, an email channel, an instant messaging channel, SMS, or other type of text based channel. In this case, communication routing system 301 determines the likelihood that the call will switch modes based on three different factors, although other examples may use more or fewer factors than three.

In particular, communication routing system 301 determines a likelihood that the voice call will switch to either text or video based on historical communication data indicating whether calls having similar context to that of the present voice call from caller system 302 have switched (503). For instance, communication routing system 301 may determine that past voice calls having similar context switched to text chat 13% of the time and to video call 67% of the time. Past statistics, such as the percentages above, allow communication routing system 301 to presume that another call having a similar context, such as the present voice call, would be likely switch to either text call or video with similar probability (e.g., 13% likely to switch to chat and 67% likely to switch to video). A past call may be considered to have similar context if the past call has the same or similar topic to the present call, is made at a similar time of day, is from the same geographic region, or has some other characteristic.

Communication routing system 301 also uses historical communication data indicating whether past calls from the caller using caller system 302 have switched to either text chat or video call mode of communicating (504). For example, communication routing system 301 may determine that the caller has never switched to text chat and has switched to video call 33% of the time. Likewise, communication routing system 301 uses historical data to determine whether other callers having similar characteristics to the caller of caller system 302 have switched to text chat or video calling (505). For instance, communication routing system 301 may determine that similar callers switched to text chat 15% of the time and to video call 60% of the time. The similar characteristics may include similar age, similar education level, similar employment position, similar products owned from the entity associated with contact center 311, or any other type of characteristic that may be beneficial for the purposes of categorizing people into groups that may be relevant for agent selection.

Using the likelihoods gathered above, communication routing system 301 determines an overall likelihood that the present voice call will switch to either text chat or video call (506). In a basic example, communication routing system 301 may simply average together the likelihood from each above determination to get an overall likelihood determination. From the example percentages above, a straight average would indicate a likelihood of 9% that the present voice call will switch to text chat and a likelihood of 53% that the present voice call will switch to a video call. In other cases, communication routing system 301 may weigh the above determinations differently. For instance, the caller's own past behavior may be weighed more heavily than the other two determinations from similar context calls and similar other callers. Likewise, if the sample set is not great enough to be considered reliable from one of the above determinations, then that determination may be weighed less than the others. For example, the present caller may have only called contact center 311 three times in the past. The fact that the caller never switched to chat and switched to video one of those three times, which would result in the 33% likelihood determination in the example above, may not be considered a large enough sample set to be indicative of whether the present call is likely to switch as well. One or more threshold sample set sizes may be used to determine how much less a particular set should be weighed or if the set should be considered at all.

Once the overall likelihood of switching is determined, communication routing system 301 compares that likelihood to a threshold likelihood to determine whether the call is likely enough to switch modes that communication routing system 301 should factor both modes into its agent selection process (507). For example, the likelihood threshold may be set at 50% where, if the voice call is more likely than not to switch to either mode (i.e., above 50% likely), then communication routing system 301 will consider the other mode when selecting an agent. Using the straight averaging example from above, the likelihood of the present call switching to text chat (9%) falls well below the 50% threshold while the likelihood of switching to a video call (53%) exceeds the 50% threshold and would, therefore, be considered likely to switch to the video call mode. Other examples may require higher thresholds or, in some cases, even lower thresholds may be used to ensure the other mode is considered just in case even though the likelihood of switching to that mode is not that great.

If communication routing system 301 determines that the present voice call is likely not going to change to a second mode, then communication routing system 301 selects an agent based on the calls current mode, voice in this case, and the topic of the call (508). Communication routing system 301 does not need to consider whether an agent is skilled in communication modes other than the current communication mode of the call because communication routing system 301 has already determined the call is unlikely to change modes.

However, if communication routing system 301 determines that the voice call is likely to change to a second mode, then communication routing system 301 selects an agent based on both the agent's skill with respect to the original mode for the call, voice in this case, and the mode to which the call is likely to change (509). Continuing from the above example, communication routing system 301 would select an agent having a high skill level in both voice calls (the current mode) and video calls (the mode to which there is a 53% likelihood that the call will change). The topic of the call is also considered since an agent's skill in a particular mode is likely not useful if the agent does not have sufficient skill in the topic of the call. Thus, communication routing system 301 may select an agent will less skill in one or both of the communication modes for a call if the agent has more topic related skill. When selecting between two or more agents having similar topic related skill, communication routing system 301 will select the agent having the best skill level across both communication modes rather than an agent is highly skilled in one mode but not the other. In some cases, this means the agent having the best skill level in one of the two modes may not be selected due to a much lower skill level in the other mode outweighing the agent's skill level in the first mode. Communication routing system 301 may average the skill levels between the two modes for each agent and select the agent with the highest average skill level across the two modes. Other metrics may also be used, including a weighted average if, for example, communication routing system 301 is to consider one communication mode as more important than the other (e.g., higher skill level in video calls may be more important than a higher skill level in voice calls). Regardless, once the agent is selected, communication routing system 301 may reserve a communication channel on the selected agent's agent system for both of the communication modes, which will ensure that a communication channel for the second mode will be available should the call switch to the second communication mode.

Referring back to scenario 400, the selected agent in this example is operating agent system 305. Therefore, communication routing system 301 establishes the voice call at step 2 with agent system 305. Upon establishment of the call, caller system 302 and agent system 305 exchange voice communications at step 3 for the caller and the agent, respectively. In this example, the caller instructs caller system 302 to request that the communication change from voice to video, as communication routing system 301 predicted would be likely in the discussion of scenario 500. The change may be instructed by the user through a client interface executing on caller system 302, through a webpage interface presented by caller system 302, or by some other means. Likewise, in other examples, the agent, via agent system 305, may instead be the one who requests the change to video.

Upon receiving the request, communication routing system 301 converts the call to video at step 5. If clients executing on caller system 302 and agent system 305 support voice and video calling, then communication routing system 301 may simply turn on the video component of the communication. In other examples, communication routing system 301 may need to transfer a link to either or both of caller system 302 and agent system 305 to access a video communication channel. Other manners of switching between communication modes may also be used including those that involve communication routing system 301 instructing one or more other systems of contact center 311 (e.g., a video communication server) to perform the conversion. Regardless, once converted, caller system 302 and agent system 305 exchange video communications, which typically includes an audio/voice component, at step 6 for the caller and the agent, respectively. Advantageously, the agent of agent system 305 should be well skilled at video communications because communication routing system 301 selected the agent based on their skill level at both voice and video communications. In some cases, the present call may also be added by communication routing system 301 to the historical data indicating that the call did switch from voice to video communications.

While the above examples determined that the communication is likely to change to only one other communication mode, in other examples, more than one communication mode may meet communication routing system 301's likelihood thresholds. For example, it may be possible that both chat and video exceeded the 50% threshold or communication routing system 301 may have determined that the voice call is likely to change modes but was unable to determine whether chat or video would be more likely. In such cases, communication routing system 301 may select an agent based on the agent's skill level in those three or more modes rather than just two, as described above.

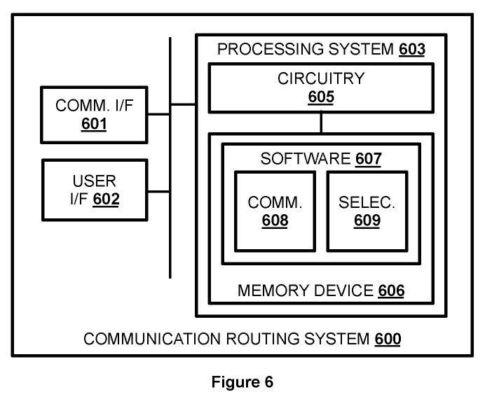

FIG. 6 illustrates communication routing system 600 for selecting a contact center agent based on the likelihood a communication will change modes. Communication routing system 600 is an example computing architecture for communication routing system 101, although system 101 may use alternative configurations. A similar architecture may also be used for a caller or agent system, although alternative configurations may also be used. Communication routing system 600 comprises communication interface 601, user interface 602, and processing system 603. Processing system 603 is linked to communication interface 601 and user interface 602. Processing system 603 includes processing circuitry 605 and memory device 606 that stores operating software 607.

Communication interface 601 comprises components that communicate over communication links, such as network cards, ports, RF transceivers, processing circuitry and software, or some other communication devices. Communication interface 601 may be configured to communicate over metallic, wireless, or optical links. Communication interface 601 may be configured to use TDM, IP, Ethernet, optical networking, wireless protocols, communication signaling, or some other communication format—including combinations thereof.

User interface 602 comprises components that interact with a user. User interface 602 may include a keyboard, display screen, mouse, touch pad, or some other user input/output apparatus. User interface 602 may be omitted in some examples.

Processing circuitry 605 comprises microprocessor and other circuitry that retrieves and executes operating software 607 from memory device 606. Memory device 606 comprises a storage medium, such as a disk drive, flash drive, data storage circuitry, or some other memory apparatus. In no examples would memory device 606 be considered a propagated signal. Operating software 607 comprises computer programs, firmware, or some other form of machine-readable processing instructions. Operating software 607 includes communication connection module 608 and agent selection module 609. Operating software 607 may further include an operating system, utilities, drivers, network interfaces, applications, or some other type of software. When executed by processing circuitry 605, operating software 607 directs processing system 603 to operate communication routing system 600 as described herein.

In particular, communication connection module 608 directs processing system 603 to receive a communication in a first mode directed to the contact center from a first user system operated by a first user. Agent selection module 609 directs processing system 603 to determine a first likelihood that, at a time after the communication is established with an agent system, the communication will change from the first mode to a second mode. Responsive to the first likelihood satisfying a threshold likelihood, agent selection module 609 directs processing system 603 to identify a first agent of the plurality of agents for handling the communication based on the first mode and the second mode. Communication connection module 608 directs processing system 603 to establish the communication in the first mode between the first user system and a first agent system operated by the first agent.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

1. A method for routing user communications to one of a plurality of agents for a contact center, the method comprising:
receiving a communication in a first mode directed to the contact center from a first user system operated by a first user;
determining a likelihood that, at a time after the communication is established with an agent system, the communication will change from the first mode to a second mode;
responsive to the likelihood satisfying a threshold likelihood, identifying a first agent of the plurality of agents for handling the communication based on skill levels of the first agent for handling communications in the first mode and the second mode; and
establishing the communication in the first mode between the first user system and a first agent system operated by the first agent.

2. The method of claim 1, wherein determining the likelihood comprises:
determining whether previous communications from the first user have changed from the first mode to the second mode.

3. The method of claim 1, wherein determining the likelihood comprises:
determining whether previous communications from one or more other users having similar attributes to the first user have changed from the first mode to the second mode.

4. The method of claim 1, wherein determining the likelihood comprises:
determining a context of the communication; and
determining whether previous communications having the same context have changed from the first mode to the second mode.

5. The method of claim 1, wherein identifying the first agent comprises:
determining a first skill level in the first mode for each of the plurality of agents;
determining a second skill level in the second mode for each of the plurality of agents; and
selecting the first agent from the plurality of agents based on the first skill level of the first agent and the second skill level of the first agent satisfying a skill level criteria.

6. The method of claim 5, further comprising:
determining a topic skill level for each agent of the plurality of agents, wherein selecting the first agent is further based on the topic skill level for the first agent satisfying the skill level criteria.

7. The method of claim 1, wherein identifying the first agent comprises:
determining that the first agent system has communication channel availability for both the first mode and the second mode.

8. The method of claim 7, further comprising:
reserving a communication channel for the second mode at the first agent system.

9. The method of claim 1, wherein the first mode comprises chat, voice, or video communications and the second mode comprises a different one of the chat, voice, or video communications than the first mode.

10. The method of claim 1, further comprising:
after establishing the communication, changing the communication from the first mode to the second mode.

11. An apparatus for routing user communications to one of a plurality of agents for a contact center, the apparatus comprising:
one or more computer readable storage media;
a processing system operatively coupled with the one or more computer readable storage media; and
program instructions stored on the one or more computer readable storage media that, when read and executed by the processing system, direct the processing system to:
receive a communication in a first mode directed to the contact center from a first user system operated by a first user;
determine a likelihood that, at a time after the communication is established with an agent system, the communication will change from the first mode to a second mode;
responsive to the likelihood satisfying a threshold likelihood, identify a first agent of the plurality of agents for handling the communication based on skill levels of the first agent for handling communications in the first mode and the second mode; and
establish the communication in the first mode between the first user system and a first agent system operated by the first agent.

12. The apparatus of claim 11, wherein to determine the likelihood, the program instructions direct the processing system to:
determine whether previous communications from the first user have changed from the first mode to the second mode.

13. The apparatus of claim 11, wherein to determine the likelihood, the program instructions direct the processing system to:
determine whether previous communications from one or more other users having similar attributes to the first user have changed from the first mode to the second mode.

14. The apparatus of claim 11, wherein to determine the likelihood, the program instructions direct the processing system to:
determining a context of the communication; and
determining whether previous communications having the same context have changed from the first mode to the second mode.

15. The apparatus of claim 11, wherein to identify the first agent, the program instructions direct the processing system to:
determine a first skill level in the first mode for each of the plurality of agents;
determine a second skill level in the second mode for each of the plurality of agents; and
select the first agent from the plurality of agents based on the first skill level of the first agent and the second skill level of the first agent satisfying a skill level criteria.

16. The apparatus of claim 15, wherein the program instructions further direct the processing system to:
determine a topic skill level for each agent of the plurality of agents, wherein selecting the first agent is further based on the topic skill level for the first agent satisfying the skill level criteria.

17. The apparatus of claim 11, wherein to identify the first agent, the program instructions direct the processing system to:
determine that the first agent system has communication channel availability for both the first mode and the second mode.

18. The apparatus of claim 17, wherein the program instructions further direct the processing system to:
reserve a communication channel for the second mode at the first agent system.

19. The apparatus of claim 11, wherein the first mode comprises chat, voice, or video communications and the second mode comprises a different one of the chat, voice, or video communications than the first mode.

20. The apparatus of claim 11, wherein the program instructions further direct the processing system to:
after establishing the communication, change the communication from the first mode to the second mode.
